(19) United States
(12) Patent Application Publication
(10) Pub. No.: US 2025/0231820 A1
(43) Pub. Date: Jul. 17, 2025

(54) PROCESSING SYSTEM CORE UTILIZATION RATIO FREQUENCY CONTROL SYSTEM

(71) Applicant: Dell Products L.P., Round Rock, TX (US)

(72) Inventors: Tzu-Hsiu Tsai, Taipei (TW); Yen-Chih Chen, New Taipei City (TW); Bang-Ning Lai, Taipei (TW); Tsung-Hsun Yang, New Taipei City (TW)

(21) Appl. No.: 18/415,199

(22) Filed: Jan. 17, 2024

(51) Int. Cl. G06F 9/50; G06F 9/38

(52) U.S. Cl. CPC G06F 9/5094; G06F 9/3885

(57) ABSTRACT

A processing system core utilization ratio frequency control system includes a core utilization ratio frequency control subsystem coupled to a processing system having multiple cores, as well as to a BMC device that is also coupled to the processing system. The core utilization ratio frequency control subsystem receives a first ambient temperature and a first processing system operating temperature of the processing system from the BMC device, and uses them to identify respective first frequency limits for different core utilization ratios of the cores in the processing system in a first core utilization ratio frequency limit profile. The core utilization ratio frequency control subsystem then configures the processing system to apply one of the respective first frequency limits to each of a subset of the cores that are currently being utilized in the processing system to provide a current core utilization ratio of the cores in the processing system.

### BACKGROUND

The present disclosure relates generally to information handling systems, and more particularly to controlling the frequencies of cores in a processing system of an information handling system based on a ratio of those cores being utilized.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices, desktop computing devices, laptop/notebook computing devices, table computing devices, mobile phones, and/or other computing devices known in the art often include processing systems having a plurality of processor cores. In some situations, a subset of the processor cores in a processing may be utilized to perform one or more workloads, which can cause issues. For example, a user that has paid to utilize a limited number of processing cores may be allocated a processing system in a server device that provides that number of processing cores via a subset of the total number of processing cores available in that processing system. As such, that subset of processing cores in the processing system will be utilized to perform the workloads provided by that user, and the inventors of the present disclosure have discovered that the use of a subset of processing cores in a processing system can result in processing system temperature “spikes” that can cause a temperature of the processing system to exceed a maximum desired temperature.

To provide a specific example, a processing system with six processor cores may be capable for performing a workload using each of those six processor cores such that those six processor cores consume a first power amount while each operating at a first frequency to cause the processing system to reach a first temperature that is below the maximum desired temperature for the processing system. However, when that processing system is configured to perform that workload using only three of its six processor cores, the three processor cores will consume a second power amount that is lower than the first amount of power, but while each operating at a second frequency that is higher than the first frequency to cause the processing system to reach a second temperature that is higher than the first temperature and that may exceed the maximum desired temperature for the processing system. In situations where the processing system exceeds its maximum desired temperature (e.g., for any duration), that event will be logged (e.g., in a System Event Log (SEL)), which may alarm a user of the server device. Furthermore, the processing system exceeding its maximum temperature results in throttling of the processing system (e.g., via Thermal Control Circuity (TCC)), and repeatedly exceeding its maximum temperature can result in wear and other negative effects on the processing system over time.

Accordingly, it would be desirable to provide a processing system control system that addresses the issues discussed above.

### SUMMARY

According to one embodiment, an Information Handling System (IHS) includes a core utilization ratio frequency control processing system; and a core utilization ratio frequency control memory system that is coupled to the core utilization ratio frequency control processing system and that includes instructions that, when executed by the core utilization ratio frequency control processing system, cause the core utilization ratio frequency control processing system to provide a core utilization ratio frequency control engine that is configured to: receive, from a Baseboard Management Controller (BMC) device, a first ambient temperature and a first primary processing system operating temperature of a primary processing system that is coupled to the core utilization ratio frequency control processing system; identify, in a first core utilization ratio frequency limit profile using the first ambient temperature and the first processing system operating temperature, respective first frequency limits for different core utilization ratios of a plurality of cores included in the primary processing system; and configure, based on a current core utilization ratio of the plurality of cores in the primary processing system, the primary processing system to apply one of the respective first frequency limits to each of a subset of the plurality of cores that are currently being utilized in the primary processing system.

### BRIEF DESCRIPTION OF THE DRAWINGS

FIG. 1 is a schematic view illustrating an embodiment of an Information Handling System (IHS).

FIG. 2 is a schematic view illustrating an embodiment of a computing device that may include the processing system core utilization ratio frequency control system of the present disclosure.

FIG. 3 is a flow chart illustrating an embodiment of a method for controlling the frequency of cores in a processing system based on a core utilization ratio.

FIG. 4 is a schematic view illustrating an embodiment of the computing device of FIG. 2 operating during the method of FIG. 3.

FIG. 5A is a schematic view illustrating an embodiment of the computing device of FIG. 2 operating during the method of FIG. 3.

FIG. 5B is a schematic view illustrating an embodiment of a core utilization ratio frequency limit profile that may be used during the method of FIG. 3.

FIG. 6 is a schematic view illustrating an embodiment of the computing device of FIG. 2 operating during the method of FIG. 3.

FIG. 7 is a schematic view illustrating an embodiment of the computing device of FIG. 2 operating during the method of FIG. 3.

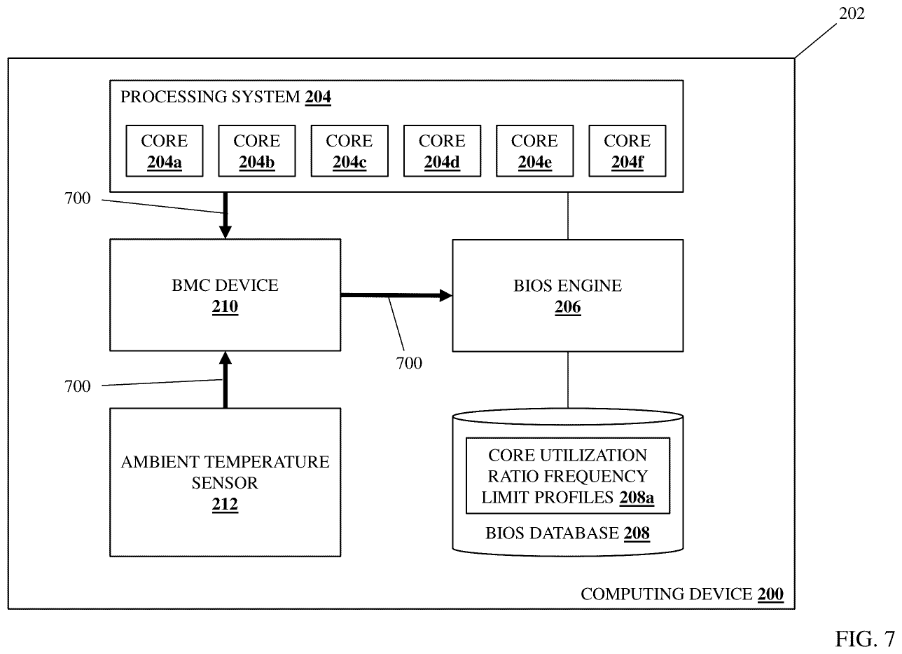

FIG. 8 is a schematic view illustrating an embodiment of the computing device of FIG. 2 operating during the method of FIG. 3.

FIG. 9A is a graph view illustrating an experimental embodiment of the results of the use of a subset of cores in a processing system without the processing system core utilization ratio frequency control system of the present disclosure.

FIG. 9B is a graph view illustrating an experimental embodiment of the results of the use of a subset of cores in a processing system with the processing system core utilization ratio frequency control system of the present disclosure.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

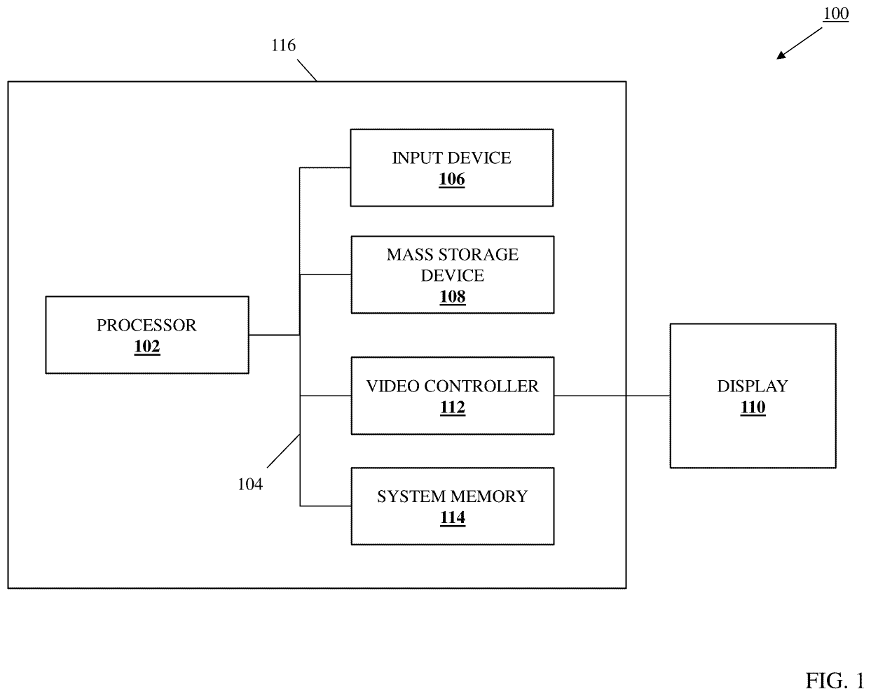

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

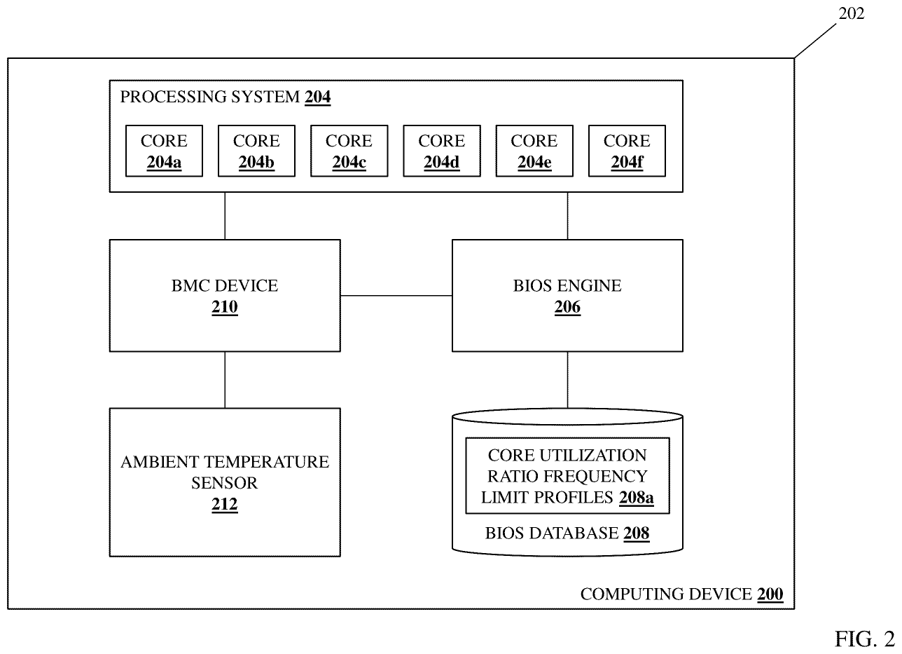

Referring now to FIG. 2, an embodiment of a computing device 200 is illustrated that may provide the processing system core utilization ratio frequency control system of the present disclosure. In an embodiment, the computing device 200 may be provided by the IHS 100 discussed above with reference to FIG. 1 and/or may include some or all of the components of the IHS 100, and in specific examples may be provided by server devices, desktop computing devices, laptop/notebook computing devices, table computing devices, mobile phones, and/or other computing devices known in the art. Furthermore, while illustrated and discussed as being provided by particular computing devices, one of skill in the art in possession of the present disclosure will recognize that the functionality of the computing device 200 discussed below may be provided by other devices that are configured to operate similarly as the computing device 200 discussed below.

In the illustrated embodiment, the computing device 200 includes a chassis 202 that houses the components of the computing device 200, only some of which are illustrated and described below. For example, in the illustrated embodiment, the chassis 202 houses a processing system 204 that one of skill in the art in possession of the present disclosure will recognize provides a “primary processing system” for the computing device. In the examples illustrated and described below, the processing system 204 includes six processor cores 204a, 204b, 204c, 204d, 204e, and 204f, but one of skill in the art in possession of the present disclosure will appreciate that the processing system 204 may be provided by any of a variety of multi-core processors that include any number of processing units or “cores” that are each configured to execute instruction while remaining within the scope of the present disclosure as well.

As discussed in further detail below, a core utilization ratio frequency control subsystem is provided in the chassis 202 and coupled to the processing system 204. In the illustrated embodiments, the core utilization ratio frequency control subsystem is provided by a Basic Input/Output System (BIOS) in the computing device 200 that is coupled to the processing system 204. For example, the chassis 202 may house a BIOS processing system (not illustrated, but which may any of a variety of BIOS firmware processing systems known in the art), and a BIOS memory system (not illustrated, but which may any of a variety of BIOS firmware memory systems known in the art) that is coupled to the BIOS processing system and that includes instructions that, when executed by the BIOS processing system, cause the BIOS processing system to provide a BIOS engine 204 that is configured to provide a BIOS that performs the functionality of the core utilization ratio frequency control engines, core utilization ratio frequency control subsystems and/or computing devices discussed below.

As will be appreciated by one of skill in the art in possession of the present disclosure, in addition to the core utilization ratio frequency control functionality described below, the BIOS provided by the BIOS engine 206 may be configured to perform hardware initialization during an initialization process (e.g., a Power-On Start-Up (POST)) for the computing device 200, runtime services for an operating system and/or other applications/programs provided on the computing device 200, and/or other BIOS functionality known in the art. Furthermore, while described as being provided by a “BIOS”, one of skill in the art in possession of the present disclosure will appreciate how the BIOS engine 206 may be replaced by a Unified Extensible Firmware Interface (UEFI) engine that is configured to provide a UEFI according to the UEFI specification, which defines the architecture of platform firmware used for initializing hardware in the computing device 200 and its interface for interaction with an operating system provided by the computing device, while remaining within the scope of the present disclosure as well. However, while the specific examples illustrated and described herein include a BIOS/UEFI that provides the core utilization ratio frequency control functionality of the present disclosure, one of skill in the art in possession of the present disclosure will appreciate how other core utilization ratio frequency control subsystems will fall within the scope of the present disclosure as well.

The chassis 202 may also house a BIOS storage system (not illustrated, but which may be similar to the storage 108 discussed above with reference to FIG. 1 and may be provided by any of a variety of BIOS storage devices) that is coupled to the BIOS engine 206 (e.g., via a coupling between the BIOS storage system and the BIOS processing system) and that includes a BIOS database 208 that is configured to store information utilized by the BIOS engine 204 discussed below. In the illustrated example, the BIOS database 208 stores a plurality of core utilization ratio frequency limit profiles 208a, but one of skill in the art in possession of the present disclosure will appreciate how the BIOS database 208 may store a variety of information utilized by the BIOS engine 206 while remaining within the scope of the present disclosure as well.

As described in further detail below, any of the core utilization ratio frequency limit profiles 208a may be determined for respective processing systems by, for example, a manufacturer of the computing device in which that processing system is provided, a manufacturer of that processing system, and/or any other entity that would be apparent to one of skill in the art in possession of the present disclosure. To provide a specific example, a thermal design team for the manufacturer of the computing device 200 may have, during the development of the computing device 200, generated a core utilization ratio frequency limit profile for the processing system 204 that is based on the thermal requirements of the processing system 204, the computing device 200, and/or any other components of the computing device 200 that would be apparent to one of skill in the art in possession of the present disclosure. As will be appreciated by one of skill in the art in possession of the present disclosure, different processing systems may have different thermal requirements (and may influence different thermal requirements in the computing device 200), and thus a different core utilization ratio frequency limit profile may be generated and provided in the BIOS database 208 for each processing system that may be provided in the computing device 200.

The chassis 202 may also house a Baseboard Management Controller (BMC) device 210 that is coupled to the processing system 204 and to the BIOS engine 206 (e.g., via a coupling between the BMC device 210 and the BIOS processing system). In an embodiment, the BMC device may be provided by an integrated DELL® Remote Access Controller (iDRAC) that may be included in server devices available from DELL® Inc. of Round Rock, Texas, United States, and that one of skill in the art in possession of the present disclosure will recognize is configured to provide an Out-Of-Band (OOB) management platform for the computing device 200 that uses resources that are mostly separate from the computing device 200 to provide a browser-based interface or Command Line Interface (CLI) for managing and monitoring hardware in the computing device 200. In the illustrated embodiment, an ambient temperature sensor 212 is included in the chassis 202 and coupled to the BMC device 210, although one of skill in the art in possession of the present disclosure will appreciate how the ambient temperature sensor 212 may be included in the BMC device 210 while remaining within the scope of the present disclosure as well.

However, while a specific computing device 200 has been illustrated and described, one of skill in the art in possession of the present disclosure will recognize that computing devices (or other devices operating according to the teachings of the present disclosure in a manner similar to that described below for the computing device 200) may include a variety of components and/or component configurations for providing conventional computing device functionality, as well as the core utilization ratio frequency control functionality discussed below, while remaining within the scope of the present disclosure as well.

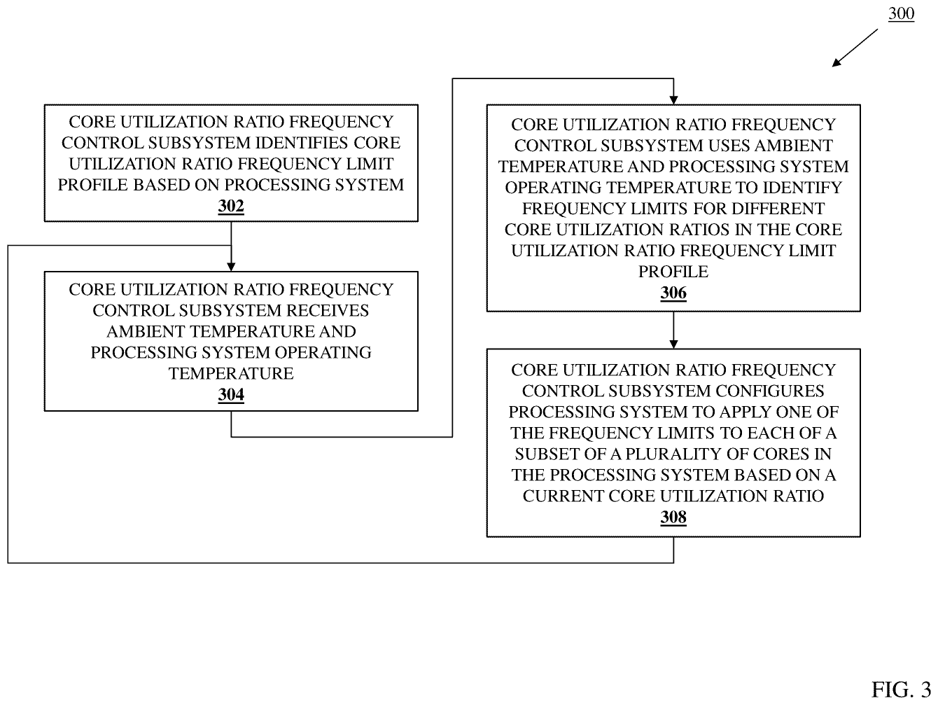

Referring now to FIG. 3, an embodiment of a method 300 for controlling the frequency of cores in a processing system based on a core utilization ratio is illustrated. As discussed below, the systems and methods of the present disclosure provide for the limiting of an operating frequency of a subset of cores in a processing system based on an ambient temperature, a processing system operating temperature of the processing system, and a core-utilization-ratio of the cores in the processing system. For example, the processing system core utilization ratio frequency control system of the present disclosure may include a core utilization ratio frequency control subsystem coupled to a processing system having a plurality of cores, as well as to a BMC device that is also coupled to the processing system. The core utilization ratio frequency control subsystem receives a first ambient temperature and a first processing system operating temperature of the processing system from the BMC device, and uses the first ambient temperature and the first processing system operating temperature to identify respective first frequency limits for different core utilization ratios of the cores in the processing system in a first core utilization ratio frequency limit profile. The core utilization ratio frequency control subsystem then configures the processing system to apply one of the respective first frequency limits to each of a subset of the cores that are currently being utilized in the processing system to provide a current core utilization ratio of the cores in the processing system. As such, the operating frequency of cores in a processing system may be limited when only a subset of those cores are being utilized in order to prevent the temperature of the processing system from exceeding a maximum desired temperature as occurs in conventional multi-core processing systems as described above.

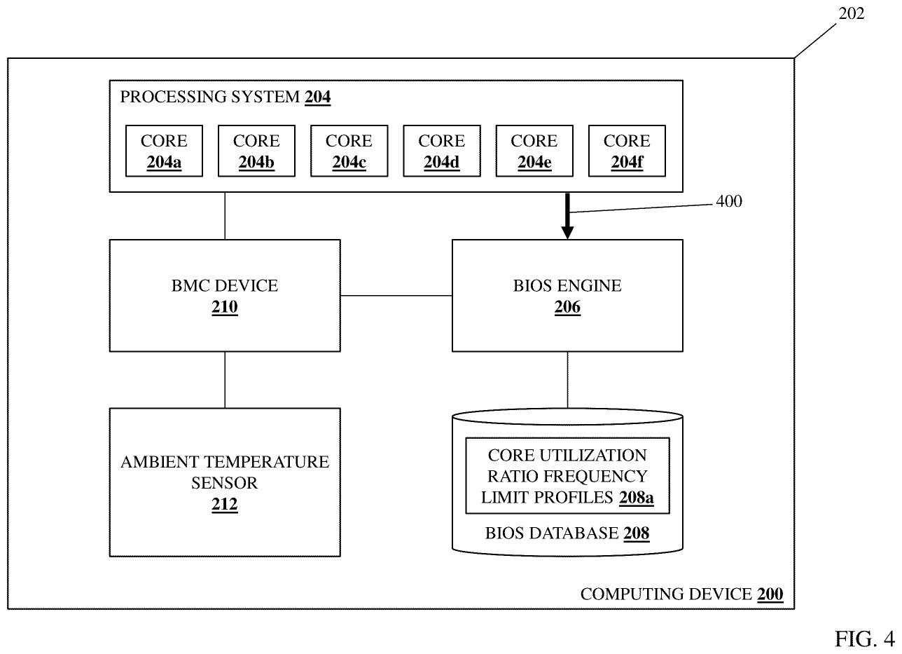

The method 300 begins at block 302 where a core utilization ratio frequency control subsystem identifies a core utilization ratio frequency limit profile based on a processing system. With reference to FIG. 4, in an embodiment of block 302, the BIOS engine 206 may perform processing system identification operations 400 that may include retrieving a processing system identifier for the processing system 204. For example, at block 302, the computing device 200 may be powered on, reset, rebooted, and/or otherwise initialized and, in response, the BIOS engine 206 may access a register in the processing system 204 that includes the processing system identifier and/or any processing system identification information that would be apparent to one of skill in the art in possession of the present disclosure, and may retrieve that processing system identifier using any of a variety of techniques known in the art. However, while a specific example of the identification of the processing system 204 has been described, one of skill in the art in possession of the present disclosure will appreciate how processing systems may be identified using other techniques while remaining within the scope of the present disclosure as well.

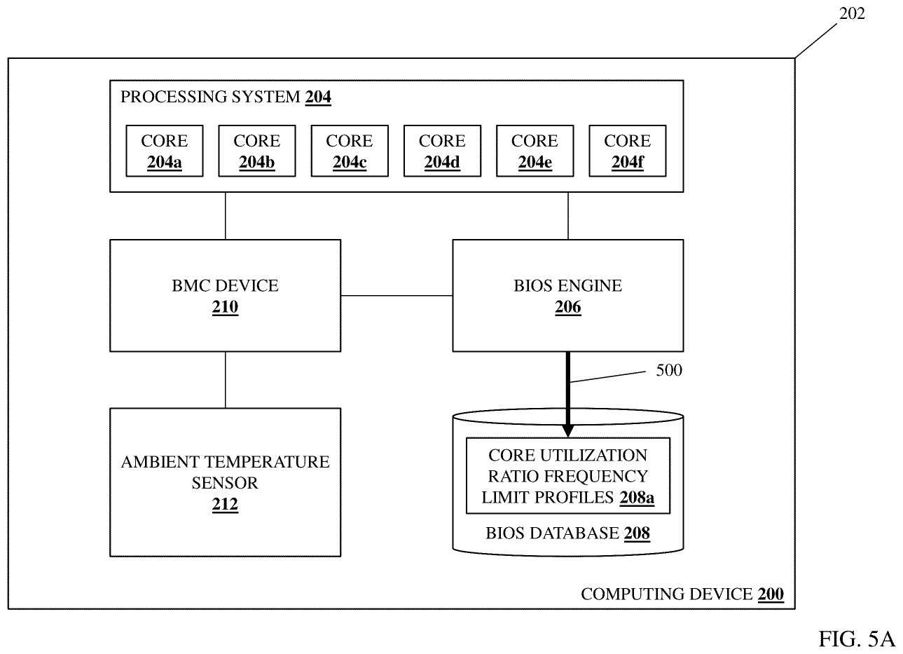

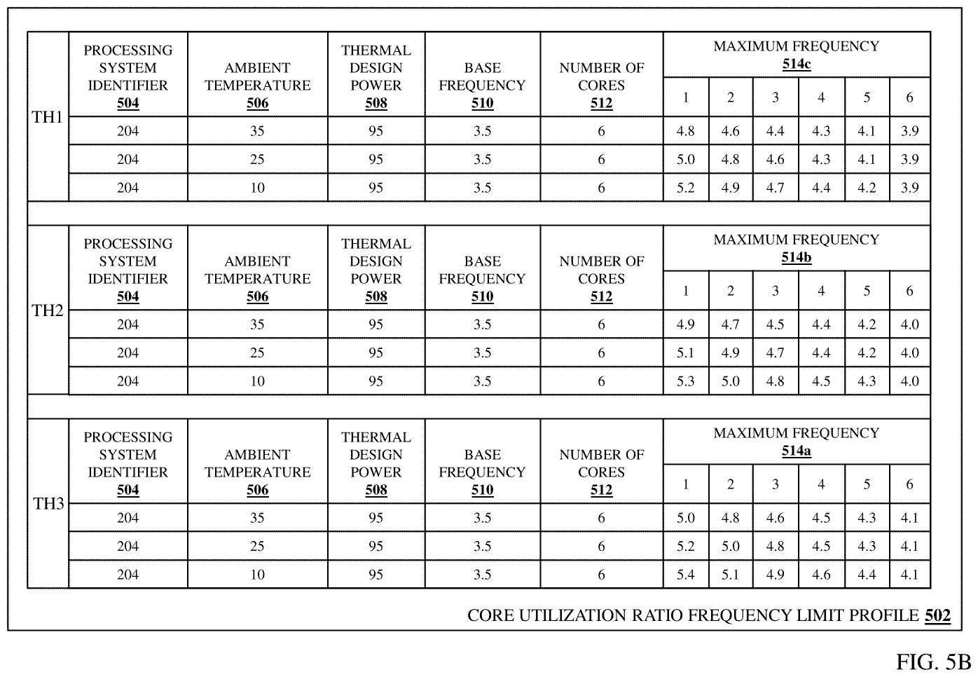

With reference to FIG. 5A, during the initialization of the computing device 200 and in response to identifying the processing system 204 at block 302, the BIOS engine 206 may perform core utilization ratio frequency limit profile identification operations 500 that may include using the processing system identifier retrieved from the processing system 204 to identify a core utilization ratio frequency limit profile for the processing system 204 from the plurality of core utilization ratio frequency limit profiles 208a stored in the BIOS database 208. For example, with reference to FIG. 5B, an embodiment of a core utilization ratio frequency limit profile 502 is illustrated that may be identified for the processing system 204 at block 302 (e.g., based on a processing system identifier “204” in the illustrated embodiment).

In the illustrated example, the core utilization ratio frequency limit profile 502 provides maximum frequency values for a relatively high elevated processing system operating temperature range “TH1” (i.e., “Temperature High 1” with a temperature between 95-97 degrees Celsius), a relatively intermediate elevated processing system operating temperature range “TH2” (i.e., “Temperature High 2” with a temperature between 90-95 degrees Celsius), and a relatively low elevated processing system operating temperature range “TH3” (i.e., “Temperature High 3” with a temperature between 80-90 degrees Celsius), and as described below, the processing system 204 may also operate to produce relatively non-elevated temperature range “TL1” (i.e., “Temperature Low 1” with a maximum temperature up to 80 degrees Celsius) for which operating frequencies of the cores 204a-204f will not be limited. However, specific examples of processing system operating temperatures for the core utilization ratio frequency limit profile are illustrated and described, one of skill in the art in possession of the present disclosure will appreciate how the core utilization ratio frequency limit profiles of the present disclosure may be provided for any types (and other granularities) of processing system operating temperatures while remaining within the scope of the present disclosure as well.

In the specific example provided in FIG. 5B, each of the processing system operating temperature ranges TH1, TH2, and TH3 is associated with a corresponding core utilization ratio frequency limit table that includes a processing system identifier column 504 that includes the processing system identifier “204” that identifies the processing system 204; an ambient temperature column 506 that identifies a relatively low ambient temperature (e.g., 10 degrees Celsius in the illustrated example), a relatively intermediate ambient temperature (e.g., 25 degrees Celsius in the illustrated example), and a relatively high ambient temperature (e.g., 35 degrees Celsius in the illustrated example); a Thermal Design Power (TDP) column 508 that identifies a TDP for the processing system 204 (e.g., 95 watts in the illustrated example); a base frequency column 510 that identifiers a base frequency for the processing system 204 (e.g., 3.5 gigahertz (GHz)); and a number of cores column 512 for the processing system 204 (e.g., 6 cores in the illustrated example).

Furthermore, the core utilization ratio frequency limit tables corresponding to the processing system operating temperature ranges TH3, TH2, and TH1 each include a core-utilization-based maximum frequency column 514a, 514b, and 514c, respectively, that identifies the maximum frequency for each core utilization ratio available in the processing system 204. For example, the core-utilization-based maximum frequency column 514a for the processing system operating temperature range TH3 provides, for an ambient temperature between 10-25 degrees Celsius, a maximum frequency (e.g., 5.4 GHz) for a “1”/6 core utilization ratio, a maximum frequency (e.g., 5.1 GHZ) for a “2”/6 core utilization ratio, a maximum frequency (e.g., 4.9 GHZ) for a “3”/6 core utilization ratio, a maximum frequency (e.g., 4.6 GHz) for a “4”/6 core utilization ratio, a maximum frequency (e.g., 4.4 GHz) for a “5”/6 core utilization ratio, and a maximum frequency (e.g., 4.1 GHZ) for a “6”/6 core utilization ratio.

Furthermore, the core-utilization-based maximum frequency column 514a for the processing system operating temperature range TH3 provides, for an ambient temperature between 25-35 degrees Celsius, a maximum frequency (e.g., 5.2 GHz) for a “1”/6 core utilization ratio, a maximum frequency (e.g., 5.0 GHz) for a “2”/6 core utilization ratio, a maximum frequency (e.g., 4.8 GHz) for a “3”/6 core utilization ratio, a maximum frequency (e.g., 4.5 GHZ) for a “4”/6 core utilization ratio, a maximum frequency (e.g., 4.3 GHZ) for a “5”/6 core utilization ratio, and a maximum frequency (e.g., 4.1 GHz) for a “6”/6 core utilization ratio. In other words, for the ambient temperature between 25-35 degrees Celsius, the core-utilization-based maximum frequency column 514a for the processing system operating temperature TH3 reduces the maximum frequency for each of the “1”/6 core utilization ratio (e.g., by 0.2 GHz) relative to its maximum frequency between 10-25 degrees Celsius, the “2”/6 core utilization ratio (e.g., by 0.1 GHz) relative to its maximum frequency between 10-25 degrees Celsius, the “3”/6 core utilization ratio (e.g., by 0.1 GHz) relative to its maximum frequency between 10-25 degrees Celsius, and the “4”/6 core utilization ratio (e.g., by 0.1 GHZ) relative to its maximum frequency between 10-25 degrees Celsius.

Furthermore, the core-utilization-based maximum frequency column 514a for the processing system operating temperature range TH3 provides, for an ambient temperature above 35 degrees Celsius, a maximum frequency (e.g., 5.0 GHz) for a “1”/6 core utilization ratio, a maximum frequency (e.g., 4.8 GHz) for a “2”/6 core utilization ratio, a maximum frequency (e.g., 4.6 GHz) for a “3”/6 core utilization ratio, a maximum frequency (e.g., 4.5 GHZ) for a “4”/6 core utilization ratio, a maximum frequency (e.g., 4.3 GHZ) for a “5”/6 core utilization ratio, and a maximum frequency (e.g., 4.1 GHz) for a “6”/6 core utilization ratio. In other words, for the ambient temperature above 35 degrees Celsius, the core-utilization-based maximum frequency column 514a for the processing system operating temperature TH3 reduces the maximum frequency for each of the “1”/6 core utilization ratio (e.g., by 0.2 GHz) relative to its maximum frequency between 25-35 degrees Celsius, the “2”/6 core utilization ratio (e.g., by 0.2 GHz) relative to its maximum frequency between 25-35 degrees Celsius, and the “3”/6 core utilization ratio (e.g., by 0.2 GHz) relative to its maximum frequency between 25-35 degrees Celsius.

Similarly, the core-utilization-based maximum frequency column 514b for the processing system operating temperature range TH2 provides, for an ambient temperature between 10-25 degrees Celsius, a maximum frequency (e.g., 5.3 GHZ) for a “1”/6 core utilization ratio, a maximum frequency (e.g., 5.0 GHz) for a “2”/6 core utilization ratio, a maximum frequency (e.g., 4.8 GHz) for a “3”/6 core utilization ratio, a maximum frequency (e.g., 4.5 GHZ) for a “4”/6 core utilization ratio, a maximum frequency (e.g., 4.3 GHZ) for a “5”/6 core utilization ratio, and a maximum frequency (e.g., 4.0 GHz) for a “6”/6 core utilization ratio. In other words, the maximum frequencies for each of the core utilization ratios for the processing system operating temperature range TH2 at the ambient temperature between 10-25 degrees Celsius is reduced by 0.1 GHz relative to the maximum frequencies for each of those core utilization ratios for the processing system operating temperature range TH3 at the ambient temperature between 10-25 degrees Celsius.

Furthermore, the core-utilization-based maximum frequency column 514b for the processing system operating temperature range TH2 provides, for the ambient temperature between 25-35 degrees Celsius, a maximum frequency (e.g., 5.1 GHz) for a “1”/6 core utilization ratio, a maximum frequency (e.g., 4.9 GHZ) for a “2”/6 core utilization ratio, a maximum frequency (e.g., 4.7 GHZ) for a “3”/6 core utilization ratio, a maximum frequency (e.g., 4.4 GHz) for a “4”/6 core utilization ratio, a maximum frequency (e.g., 4.2 GHz) for a “5”/6 core utilization ratio, and a maximum frequency (e.g., 4.0 GHz) for a “6”/6 core utilization ratio. In other words, for the ambient temperature between 25-35 degrees Celsius, the core-utilization-based maximum frequency column 514b for the processing system operating temperature range TH2 reduces the maximum frequency for each of the “1”/6 core utilization ratio (e.g., by 0.2 GHz) relative to its maximum frequency between 10-25 degrees Celsius, the “2”/6 core utilization ratio (e.g., by 0.1 GHz) relative to its maximum frequency between 10-25 degrees Celsius, the “3”/6 core utilization ratio (e.g., by 0.1 GHz) relative to its maximum frequency between 10-25 degrees Celsius, and the “4”/6 core utilization ratio (e.g., by 0.1 GHz) relative to its maximum frequency between 10-25 degrees Celsius.

Furthermore, the core-utilization-based maximum frequency column 514b for the processing system operating temperature range TH2 provides, for an ambient temperature above 35 degrees Celsius, a maximum frequency (e.g., 4.9 GHZ) for a “1”/6 core utilization ratio, a maximum frequency (e.g., 4.7 GHZ) for a “2”/6 core utilization ratio, a maximum frequency (e.g., 4.5 GHZ) for a “3”/6 core utilization ratio, a maximum frequency (e.g., 4.4 GHz) for a “4”/6 core utilization ratio, a maximum frequency (e.g., 4.2 GHz) for a “5”/6 core utilization ratio, and a maximum frequency (e.g., 4.0 GHz) for a “6”/6 core utilization ratio. In other words, for the ambient temperature above 35 degrees Celsius, the core-utilization-based maximum frequency column 514b for the processing system operating temperature range TH2 reduces the maximum frequency for each of the “1”/6 core utilization ratio (e.g., by 0.2 GHz) relative to its maximum frequency between 25-35 degrees Celsius, the “2”/6 core utilization ratio (e.g., by 0.2 GHz) relative to its maximum frequency between 25-35 degrees Celsius, and the “3”/6 core utilization ratio (e.g., by 0.2 GHz) relative to its maximum frequency between 25-35 degrees Celsius.

Similarly, the core-utilization-based maximum frequency column 514c for the processing system operating temperature range TH1 provides, for an ambient temperature between 10-25 degrees Celsius, a maximum frequency (e.g., 5.2 GHz) for a “1”/6 core utilization ratio, a maximum frequency (e.g., 4.9 GHz) for a “2”/6 core utilization ratio, a maximum frequency (e.g., 4.7 GHZ) for a “3”/6 core utilization ratio, a maximum frequency (e.g., 4.4 GHz) for a “4”/6 core utilization ratio, a maximum frequency (e.g., 4.2 GHz) for a “5”/6 core utilization ratio, and a maximum frequency (e.g., 3.9 GHZ) for a “6”/6 core utilization ratio. In other words, the maximum frequencies for each of the core utilization ratios for the processing system operating temperature range TH1 at the ambient temperature between 10-25 degrees Celsius is reduced by 0.1 GHz relative to the maximum frequencies for each of those core utilization ratios for the processing system operating temperature range TH2 at the ambient temperature between 10-25 degrees Celsius.

Furthermore, the core-utilization-based maximum frequency column 514c for the processing system operating temperature range TH1 provides, for an ambient temperature between 25-35 degrees Celsius, a maximum frequency (e.g., 5.0 GHz) for a “1”/6 core utilization ratio, a maximum frequency (e.g., 4.8 GHz) for a “2”/6 core utilization ratio, a maximum frequency (e.g., 4.6 GHz) for a “3”/6 core utilization ratio, a maximum frequency (e.g., 4.3 GHZ) for a “4”/6 core utilization ratio, a maximum frequency (e.g., 4.1 GHZ) for a “5”/6 core utilization ratio, and a maximum frequency (e.g., 3.9 GHZ) for a “6”/6 core utilization ratio. In other words, for the ambient temperature 25-35 degrees Celsius, the core-utilization-based maximum frequency column 514c for the processing system operating temperature range TH1 reduces the maximum frequency for each of the “1”/6 core utilization ratio (e.g., by 0.2 GHz) relative to its maximum frequency between 10-25 degrees Celsius, the “2”/6 core utilization ratio (e.g., by 0.1 GHZ) relative to its maximum frequency between 10-25 degrees Celsius, the “3”/6 core utilization ratio (e.g., by 0.1 GHZ) relative to its maximum frequency between 10-25 degrees Celsius, and the “4”/6 core utilization ratio (e.g., by 0.1 GHz) relative to its maximum frequency between 10-25 degrees Celsius.

Furthermore, the core-utilization-based maximum frequency column 514c for the processing system operating temperature range TH1 provides, for an ambient temperature above 35 degrees Celsius, a maximum frequency (e.g., 4.8 GHz) for a “1”/6 core utilization ratio, a maximum frequency (e.g., 4.6 GHz) for a “2”/6 core utilization ratio, a maximum frequency (e.g., 4.4 GHZ) for a “3”/6 core utilization ratio, a maximum frequency (e.g., 4.3 GHZ) for a “4”/6 core utilization ratio, a maximum frequency (e.g., 4.1 GHZ) for a “5”/6 core utilization ratio, and a maximum frequency (e.g., 3.9 GHZ) for a “6”/6 core utilization ratio. In other words, for the ambient temperature above 35 degrees Celsius, the core-utilization-based maximum frequency column 514c for the processing system operating temperature range TH1 reduces the maximum frequency for each of between 25-35 degrees the “1”/6 core utilization ratio (e.g., by 0.2 GHz) relative to its maximum frequency between 25-35 degrees Celsius, the “2”/6 core utilization ratio (e.g., by 0.2 GHz) relative to its maximum frequency between 25-35 degrees Celsius, and the “3”/6 core utilization ratio (e.g., by 0.2 GHz) relative to its maximum frequency between 25-35 degrees Celsius.

As will be appreciated by one of skill in the art in possession of the present disclosure, in some embodiments the maximum frequency for the cores 204a-204f in the processing system 204 may not differ across different core utilization ratios when the processing system 204 is operating at the processing system operating temperature range TL1 (i.e., a single maximum frequency may be applied to any core operating in the processing system 204 in the processing system operating temperature range TL1). However, one of skill in the art in possession of the present disclosure will appreciate how the processing system operating temperature range TL1 may be associated with a core-utilization-based maximum frequency column that is similar to the core-utilization-based maximum frequency columns 514a, 514b, and 514c discussed above while remaining within the scope of the present disclosure as well. Furthermore, while a specific core utilization ratio frequency limit profile has been described, one of skill in the art in possession of the present disclosure will appreciate how the frequency limit of cores in a processing system may be limited similarly as described below in other manners that will fall within the scope of the present disclosure as well.

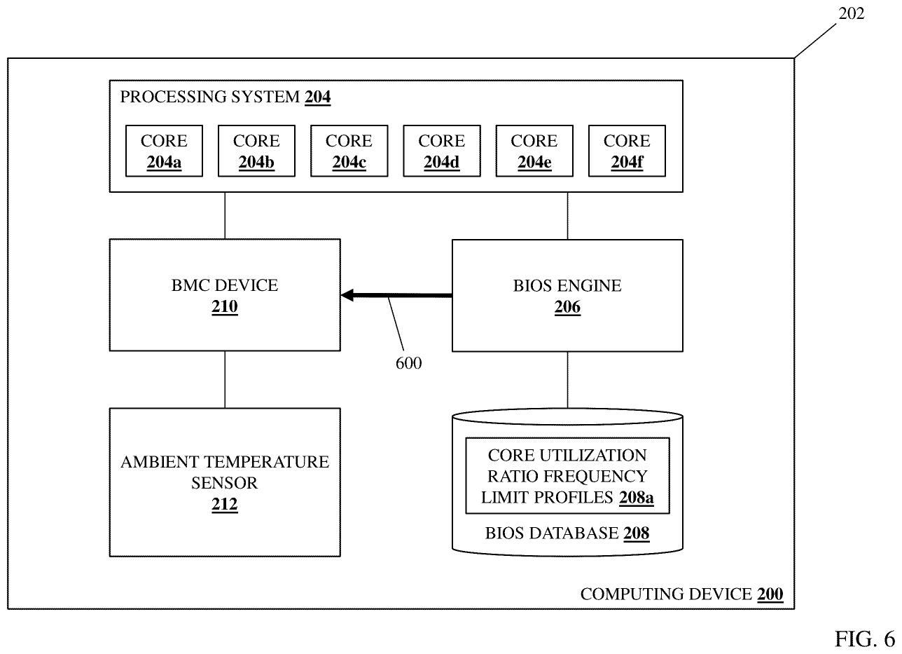

With reference to FIG. 6, during the initialization of the computing device 200 and at block 302, the BIOS engine 206 may perform processing system operating temperature definition provisioning operations 600 that may include providing a processing system operating temperature definition to the BMC device 210. For example, as discussed above the BIOS engine 206 may define the temperatures of the processing system 204 to fall within the relatively high elevated processing system operating temperature range TH1 (e.g., 95-97 degrees Celsius), the relatively intermediate elevated processing system operating temperature range TH2 (e.g., 90-95 degrees Celsius), and the relatively low elevated processing system operating temperature range TH3 (e.g., 80-90 degrees Celsius), as well as in a relatively non-elevated temperature range TL1. (e.g., below 80 degrees Celsius), and at block 302 the BIOS engine may identify those processing system operating temperature definitions to the BMC device 210. However, while specific examples of processing system operating temperature definitions are provided, one of skill in the art in possession of the present disclosure will appreciate how processing system operating temperatures may be defined in a variety of manners that will fall within the scope of the present disclosure as well.

Furthermore, while described as having processing system operating temperature definition provided to it at block 302, in other embodiments the BMC device 210 may store different processing system operating temperature definitions in its database in association with different processing system identifiers. As such, at block 302, the BMC device 210 may identify (e.g., directly, via an identification provided by the BIOS engine 206, etc.) the processing system 204 and, in response, use the identification of the processing system 204 to determine a corresponding processing system operating temperature definition in its database.

The method 300 then proceeds to block 304 where the core utilization ratio frequency control subsystem receives an ambient temperature and a processing system operating temperature. In an embodiment, at block 304 and following initialization of the computing device 200 such that the computing device 200 enters a runtime state in which an operating system controls the computing device 200, the BMC device 210 may perform temperature reporting operations 700 that may include retrieving an ambient temperature from the ambient temperature sensor 212, retrieving a processing system operating temperature from the processing system 204 (e.g., a current operating temperature of the processing system 204 generated by a temperature sensor in the processing system 204), and providing the ambient temperature and the processing system operating temperature to the BIOS engine 206.

For example, in response to retrieving the processing system operating temperature, the BMC device 210 may translate that processing system operating temperature based on the processing system operating temperature definitions described above (e.g., “TL1” for processing system operating temperature below 80 degrees Celsius, “TH3” for processing system operating temperature between 80-90 degrees Celsius, “TH2” for processing system operating temperature between 90-95 degrees Celsius, or “TH1” for processing system operating temperature between 95-97 degrees Celsius). The BMC device may then generate and transmit a System Management Interrupt (SMI) that includes the ambient temperature and the translated processing system operating temperature (e.g., an ambient temperature of 28 degrees Celsius and a processing system operating temperature of “TH2”), and may provide that SMI to the BIOS engine 206.

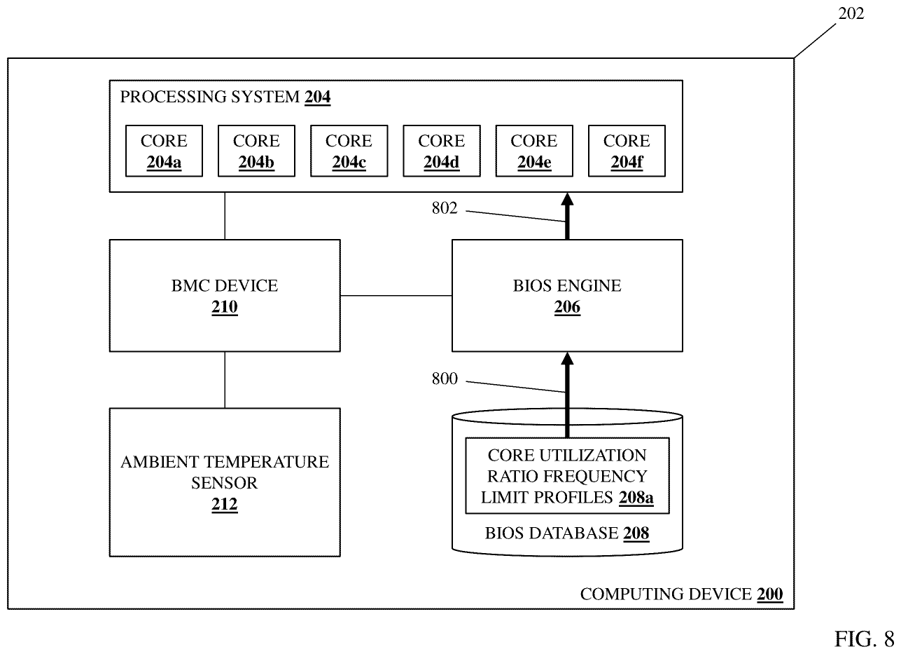

The method 300 then proceeds to block 306 where the core utilization ratio frequency control subsystem uses the ambient temperature and the processing system operating temperature to identify frequency limits for different core utilization ratios in the core utilization ratio frequency limit profile. With reference to FIG. 8, in an embodiment of block 306, the BIOS engine 206 may perform frequency limit identification operations 800 that may include using the processing system operating temperature and the ambient temperature received from the BMC device 210 to identify a row in a maximum frequency column of the core utilization ratio frequency limit profile 502 that includes respective frequency limits for different core utilization ratios of the cores 204a-204f in the processing system 204. For example, with reference back to FIG. 5B, for a processing system operating temperature “TH3” and an ambient temperature between 25-35 degrees Celsius, the BIOS engine 206 may identify the middle row in the maximum frequency column 514a that include the maximum frequency of 5.2 GHz for the “1”/6 core utilization ratio, the maximum frequency of 5.0 GHz for the “2”/6 core utilization ratio, the maximum frequency of 4.8 GHz for the “3”/6 core utilization ratio, the maximum frequency of 4.5 GHz for the “4”/6 core utilization ratio, the maximum frequency of 4.3 GHZ for the “5”/6 core utilization ratio, and the maximum frequency of 4.1 GHz for the “6”/6 core utilization ratio.

Similarly, for a processing system operating temperature “TH2” and an ambient temperature between above 35 degrees Celsius, the BIOS engine 206 may identify the top row in the maximum frequency column 514b that include the maximum frequency of 4.9 GHz for the “1”/6 core utilization ratio, the maximum frequency of 4.7 GHz for the “2”/6 core utilization ratio, the maximum frequency of 4.5 GHz for the “3”/6 core utilization ratio, the maximum frequency of 4.4 GHz for the “4”/6 core utilization ratio, the maximum frequency of 4.2 GHz for the “5”/6 core utilization ratio, and the maximum frequency of 4.0 GHz for the “6”/6 core utilization ratio. Similarly, for a processing system operating temperature “TH1” and an ambient temperature above 35 degrees Celsius, the BIOS engine 206 may identify the top row in the maximum frequency column 514c that include the maximum frequency of 4.8 GHz for the “1”/6 core utilization ratio, the maximum frequency of 4.6 GHz for the “2”/6 core utilization ratio, the maximum frequency of 4.4 GHz for the “3”/6 core utilization ratio, the maximum frequency of 4.3 GHz for the “4”/6 core utilization ratio, the maximum frequency of 4.1 GHz for the “5”/6 core utilization ratio, and the maximum frequency of 3.9 GHz for the “6”/6 core utilization ratio.

The method 300 then proceeds to block 308 where the core utilization ratio frequency control subsystem configures the processing system to apply one of the frequency limits to each of a subset of a plurality of cores in the processing system based on a current core utilization ratio. With continued reference to FIG. 8, in an embodiment of block 308, the BIOS engine 206 may perform processing system configuration operations 802 that include configuring the processing system 204 to apply one of the frequency limits identified in the core utilization ratio frequency limit profile 502 to each of a subset of its cores 204a-204f based on a current core utilization ratio. For example, at block 308, the BIOS engine 206 may set one or more registers in the processing system 204 in order to configure the processing system 204 to apply one of the frequency limits identified in the core utilization ratio frequency limit profile 502 to each of a subset of its cores 204a-204f based on a current core utilization ratio.

In a specific example, at block 308 the BIOS engine 206 may configure the processing system 204 with a plurality of frequency limits identified in the core utilization ratio frequency limit profile 502. For example, for the processing system operating temperature “TH3” and the ambient temperature between 25-35 degrees Celsius described above, the BIOS engine 206 may configure the processing system with each of the frequency limits included in the middle row in the maximum frequency column 514a, thus allowing the processing system 204 to select one of those frequency limits to apply based on its current core utilization ratio (e.g., any of the “1”-“6”/6 core utilization ratios described above). Similarly, for the processing system operating temperature “TH2” and the ambient temperature above 35 degrees Celsius described above, the BIOS engine 206 may configure the processing system with each of the frequency limits included in the top row in the maximum frequency column 514b, thus allowing the processing system 204 to select one of those frequency limits to apply based on its current core utilization ratio (e.g., any of the “1”-“6”/6 core utilization ratios described above). Similarly as well, for the processing system operating temperature “TH1” and the ambient temperature above 35 degrees Celsius described above, the BIOS engine 206 may configure the processing system with each of the frequency limits included in the top row in the maximum frequency column 514a, thus allowing the processing system 204 to select one of those frequency limits to apply based on its current core utilization ratio (e.g., any of the “1”-“6”/6 core utilization ratios described above).

However, in another specific example, at block 308 the BIOS engine 206 may identify a current core utilization ratio for the processing system 204 (e.g., any of the “1”-“6”/6 core utilization ratios described above), may use that current core utilization ratio to identify a frequency limit in the core utilization ratio frequency limit profile 502, and configure the processing system 204 with that frequency limit. For example, for a current core utilization ratio of “3”/6 (i.e., the processing system 204 is currently utilizing three cores 204a, 204b, and 204c), the BIOS engine 206 may identify and configure the processing system 204 with the frequency limit of 4.8 GHz for the processing system operating temperature “TH3” and the ambient temperature between 25-35 degrees Celsius described above, may identify and configure the processing system 204 with the frequency limit of 4.5 GHz for the processing system operating temperature “TH2” and the ambient temperature above 35 degrees Celsius described above, and may identify and configure the processing system 204 with the frequency limit of 4.4 GHz for the processing system operating temperature “TH1” and the ambient temperature above 35 degrees Celsius described above.

As such, following block 308, the processing system 204 may apply the frequency limit to the subset of its cores 204a-204f that are currently being utilized. The method 300 may then return to block 304 and may loop such that the BIOS engine 206 may periodically receive an updated ambient temperature and/or an updated processing system operating temperature and, in response, may modify the frequency limit for any subset of the cores 204a-204f in the processing system 204 based on the core utilization ratio frequency limit profile 502 similarly as described above.

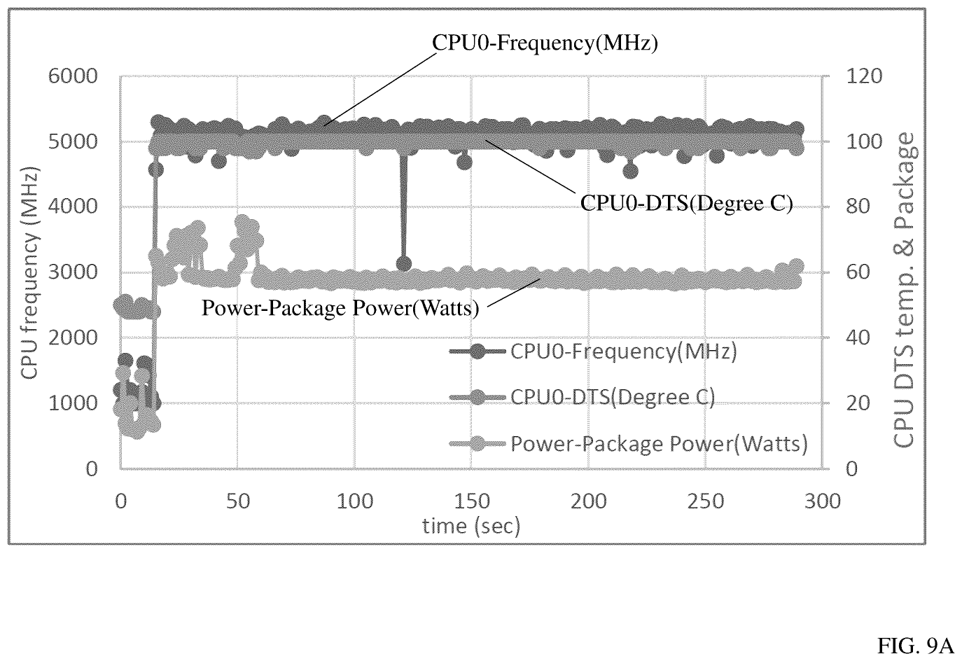

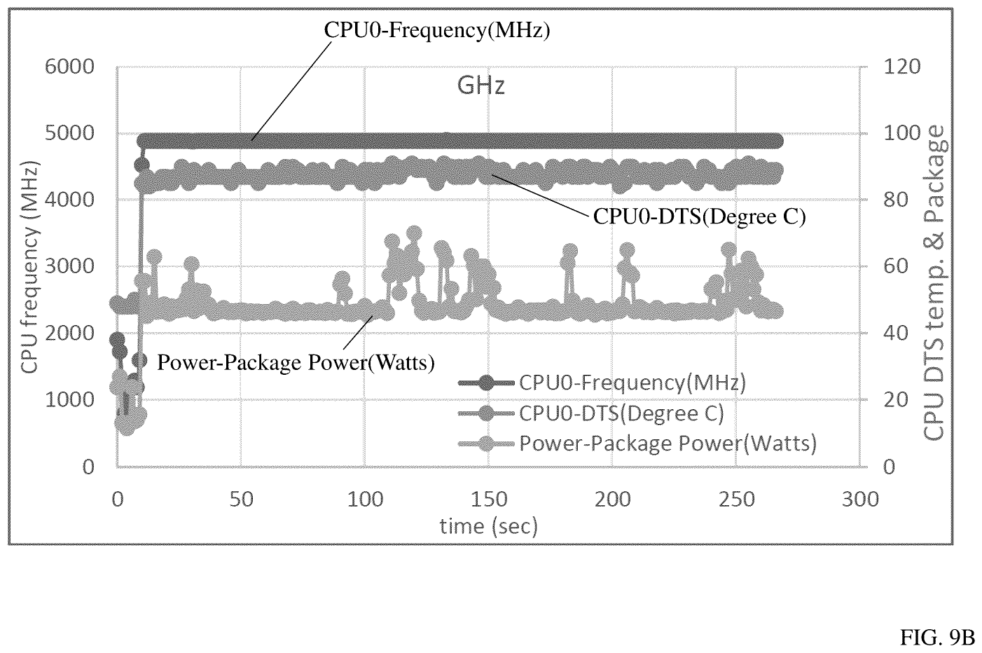

With reference to FIGS. 9A and 9B, experimental embodiments were performed to test the efficacy of the systems and methods of the present disclosure. For example, FIG. 9A illustrates an example in which 1 core in a 6 core, 95-watt processing system was utilized to perform a workload with no frequency limit applied to the processing system. As can be seen in FIG. 9A, the processing system operated at a frequency above 5 GHz at a temperature of approximately 100 watts. FIG. 9B illustrates an example in which 1 core in the 6 core, 95 watt processing system was utilized to perform a workload with a frequency limit of 4.9 GHz applied to the processing system as per the teachings of the present disclosure. As can be seen in FIG. 9B, the processing system operated at a frequency of 4.9 GHz at a temperature below ˜90 watts. As such, one of skill in the art in possession of the present disclosure will recognize how the frequency limits may be applied to the utilization of any subset of cores in a processing system to limit the operating temperature of the processing system in order to, for example, prevent the processing system from reaching or exceeding its maximum temperature, prevent the logging of maximum temperature excursions, and/or other preventing issues that would be apparent to one of skill in the art in possession of the present disclosure.

Thus, systems and methods have been described that provide for the limiting of an operating frequency of a subset of cores in a processing system based on an ambient temperature, a processing system operating temperature of the processing system, and a core-utilization-ratio of the cores in the processing system. For example, the processing system core utilization ratio frequency control system of the present disclosure may include a core utilization ratio frequency control subsystem coupled to a processing system having a plurality of cores, as well as to a BMC device that is also coupled to the processing system. The core utilization ratio frequency control subsystem receives a first ambient temperature and a first processing system operating temperature of the processing system from the BMC device, and uses the first ambient temperature and the first processing system operating temperature to identify respective first frequency limits for different core utilization ratios of the cores in the processing system in a first core utilization ratio frequency limit profile. Based on a current core utilization ratio of the cores in the processing system, the core utilization ratio frequency control subsystem configures the processing system to apply one of the respective first frequency limits to each of a subset of the cores that are currently being utilized in the processing system. As such, the operating frequency of cores in a processing system may be limited when only a subset of those cores are being utilized in order to prevent the temperature of the processing system from exceeding a maximum desired temperature as occurs in conventional multi-core processing systems as described above.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A processing system core utilization ratio frequency control system, comprising:
a processing system including a plurality of cores;
a Baseboard Management Controller (BMC) device that is coupled to the processing system; and
a core utilization ratio frequency control subsystem that is coupled to the processing and the BMC device, wherein the core utilization ratio frequency control subsystem is configured to:
receive, from the BMC device, a first ambient temperature and a first processing system operating temperature of the processing system;
identify, in a first core utilization ratio frequency limit profile using the first ambient temperature and the first processing system operating temperature, respective first frequency limits for different core utilization ratios of the plurality of cores included in the processing system; and
configure, based on a current core utilization ratio of the plurality of cores in the processing system, the processing system to apply one of the respective first frequency limits to each of a subset of the plurality of cores that are currently being utilized in the processing system.

2. The system of claim 1, wherein the core utilization ratio frequency control subsystem is provided by a Basic Input/Output System (BIOS).

3. The system of claim 1, wherein the core utilization ratio frequency control subsystem is configured to:
retrieve, from the processing system, a processing system identifier; and
identify, in a database that includes a plurality of core utilization ratio frequency limit profiles, the first core utilization ratio frequency limit profile using the processing system identifier.

4. The system of claim 1, wherein the core utilization ratio frequency control subsystem is configured to:
receive, from the BMC device, a second ambient temperature that is different than the first ambient temperature, and the first processing system operating temperature of the processing system;
identify, in the first core utilization ratio frequency limit profile using the second ambient temperature and the first processing system operating temperature, respective second frequency limits for different core utilization ratios of the plurality of cores included in the processing system, wherein one or more of the respective second frequency limits are different than the respective first frequency limits; and
configure, based on the current core utilization ratio of the plurality of cores in the processing system, the processing system to apply one of the respective second frequency limits to each of the subset of the plurality of cores that are currently being utilized in the processing system.

5. The system of claim 1, wherein the core utilization ratio frequency control subsystem is configured to:
receive, from the BMC device, the first ambient temperature and a second processing system operating temperature of the processing system that is different than the first processing system operating temperature;
identify, in a second core utilization ratio frequency limit profile that is different than the first core utilization ratio frequency limit profile using the first ambient temperature and the second processing system operating temperature, respective second frequency limits for different core utilization ratios of the plurality of cores included in the processing system; and
configure, based on the current core utilization ratio of the plurality of cores in the processing system, the processing system to apply one of the respective second frequency limits to each of the subset of the plurality of cores that are currently being utilized in the processing system.

6. The system of claim 1, wherein the configuring the processing system to apply one of the respective first frequency limits to each of the subset of the plurality of cores that are currently being utilized in the processing system includes:
reprogramming a frequency register in the processing system.

7. An Information Handling System (IHS), comprising:
a core utilization ratio frequency control processing system; and
a core utilization ratio frequency control memory system that is coupled to the core utilization ratio frequency control processing system and that includes instructions that, when executed by the core utilization ratio frequency control processing system, cause the core utilization ratio frequency control processing system to provide a core utilization ratio frequency control engine that is configured to:
receive, from a Baseboard Management Controller (BMC) device, a first ambient temperature and a first primary processing system operating temperature of a primary processing system that is coupled to the core utilization ratio frequency control processing system;
identify, in a first core utilization ratio frequency limit profile using the first ambient temperature and the first processing system operating temperature, respective first frequency limits for different core utilization ratios of a plurality of cores included in the primary processing system; and
configure, based on a current core utilization ratio of the plurality of cores in the primary processing system, the primary processing system to apply one of the respective first frequency limits to each of a subset of the plurality of cores that are currently being utilized in the primary processing system.

8. The IHS of claim 7, wherein the core utilization ratio frequency control processing system is provided by a Basic Input/Output System (BIOS) processing system, and the core utilization ratio frequency control memory system is provided by a BIOS memory system that include instruction that, when executed by the BIOS processing system, cause the BIOS processing system to provide a BIOS.

9. The IHS of claim 7, wherein the core utilization ratio frequency control engine is configured to:
retrieve, from the primary processing system, a primary processing system identifier; and
identify, in a database that includes a plurality of core utilization ratio frequency limit profiles, the first core utilization ratio frequency limit profile using the primary processing system identifier.

10. The IHS of claim 7, wherein the core utilization ratio frequency control engine is configured to:
receive, from the BMC device, a second ambient temperature that is different than the first ambient temperature, and the first primary processing system operating temperature of the primary processing system;
identify, in the first core utilization ratio frequency limit profile using the second ambient temperature and the first primary processing system operating temperature, respective second frequency limits for different core utilization ratios of the plurality of cores included in the primary processing system, wherein one or more of the respective second frequency limits are different than the respective first frequency limits; and
configure, based on the current core utilization ratio of the plurality of cores in the primary processing system, the primary processing system to apply one of the respective second frequency limits to each of the subset of the plurality of cores that are currently being utilized in the primary processing system.

11. The IHS of claim 7, wherein the core utilization ratio frequency control engine is configured to:
receive, from the BMC device, the first ambient temperature and a second primary processing system operating temperature of the primary processing system that is different than the first primary processing system operating temperature;
identify, in a second core utilization ratio frequency limit profile that is different than the first core utilization ratio frequency limit profile using the first ambient temperature and the second primary processing system operating temperature, respective second frequency limits for different core utilization ratios of the plurality of cores included in the primary processing system; and
configure, based on the current core utilization ratio of the plurality of cores in the primary processing system, the primary processing system to apply one of the respective second frequency limits to each of the subset of the plurality of cores that are currently being utilized in the primary processing system.

12. The IHS of claim 7, wherein the configuring the primary processing system to apply one of the respective first frequency limits to each of the subset of the plurality of cores that are currently being utilized in the primary processing system includes:
reprogramming a frequency register in the primary processing system.

13. The IHS of claim 7, wherein the respective first frequency limits are core turbo frequency limits.

14. A method for controlling the frequency of cores in a processing system based on a core utilization ratio, comprising:
receiving, by a core utilization ratio frequency control subsystem from a Baseboard Management Controller (BMC) device, a first ambient temperature and a first processing system operating temperature of a processing system;
identifying, by the core utilization ratio frequency control subsystem in a first core utilization ratio frequency limit profile using the first ambient temperature and the first processing system operating temperature, respective first frequency limits for different core utilization ratios of the plurality of cores included in the processing system; and
configuring, the core utilization ratio frequency control subsystem based on a current core utilization ratio of the plurality of cores in the processing system, the processing system to apply one of the respective first frequency limits to each of a subset of the plurality of cores that are currently being utilized in the processing system.

15. The method of claim 14, wherein the core utilization ratio frequency control subsystem is provided by a Basic Input/Output System (BIOS).

16. The method of claim 14, further comprising:
retrieving, the core utilization ratio frequency control subsystem from the processing system, a processing system identifier; and
identifying, the core utilization ratio frequency control subsystem in a database that includes a plurality of core utilization ratio frequency limit profiles, the first core utilization ratio frequency limit profile using the processing system identifier.

17. The method of claim 14, further comprising:
receiving, the core utilization ratio frequency control subsystem from the BMC device, a second ambient temperature that is different than the first ambient temperature, and the first processing system operating temperature of the processing system;
identifying, the core utilization ratio frequency control subsystem in the first core utilization ratio frequency limit profile using the second ambient temperature and the first processing system operating temperature, respective second frequency limits for different core utilization ratios of the plurality of cores included in the processing system, wherein one or more of the respective second frequency limits are different than the respective first frequency limits; and
configuring, the core utilization ratio frequency control subsystem based on the current core utilization ratio of the plurality of cores in the processing system, the processing system to apply one of the respective second frequency limits to each of the subset of the plurality of cores that are currently being utilized in the processing system.

18. The method of claim 14, further comprising:
receiving, the core utilization ratio frequency control subsystem from the BMC device, the first ambient temperature and a second processing system operating temperature of the processing system that is different than the first processing system operating temperature;
identifying, the core utilization ratio frequency control subsystem in a second core utilization ratio frequency limit profile that is different than the first core utilization ratio frequency limit profile using the first ambient temperature and the second processing system operating temperature, respective second frequency limits for different core utilization ratios of the plurality of cores included in the processing system; and
configuring, the core utilization ratio frequency control subsystem based on the current core utilization ratio of the plurality of cores in the processing system, the processing system to apply one of the respective second frequency limits to each of the subset of the plurality of cores that are currently being utilized in the processing system.

19. The method of claim 14, wherein the configuring the processing system to apply one of the respective first frequency limits to each of the subset of the plurality of cores that are currently being utilized in the processing system includes:
reprogramming, the core utilization ratio frequency control subsystem, a frequency register in the processing system.

20. The method of claim 14, wherein the respective first frequency limits are core turbo frequency limits.
